(19) United States
(12) Patent Application Publication
(10) Pub. No.: US 2009/0101374 A1
(43) Pub. Date: Apr. 23, 2009

(54) WEED REMOVAL GARDEN HAND TOOL

(76) Inventor: Rhonda GENEST, Varennes (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/873,459

(22) Filed: Oct. 17, 2007

(51) Int. Cl. A01B 1/18

(52) U.S. Cl. 172/378

(57) ABSTRACT

A plant bed grooming garden tool and particularly for de-weeding plant beds is provided in the form of a scoop having a forward cutting portion integrally formed with a rear basket portion. The root cutting portion has projecting spaced-apart fingers extending from a forward cutting edge of a bottom wall of the rear basket portion. Opposed ones of the fingers have upwardly formed side flanges merging with opposed side walls of the rear basket portion. At least the bottom wall of the basket portion has through bore formations shaped and disposed to permit the passage of earth while retaining earth matter larger than the through bore formations. The basket retains the weeds, cut roots and other earth matter therein while permitting earth to be shaken out of the weed basket portion. A handle is secured to an upstanding rear wall of the basket portion.

### TECHNICAL FIELD

The present invention relates to an efficient weed removal garden hand tool and particularly one with a scoop having a weed retaining basket and forwardly projecting fingers and easily displaceable in earth to sever roots and retain the weeds in the basket.

### BACKGROUND ART

Weed removal garden tools are known and these have been proven to be ineffective in providing ease of removal of weeds, particularly in flower bed areas and along the edges of paved surfaces or straight edge cut grass areas.

Examples of such prior art garden tools for removal of weeds are described in U.S. Pat. No. 2,909,385 and British Patent Nos. GB 2 212 373 and 2 250 170. The garden tools as illustrated and described in those patents show a shovel-type tool which is provided with a sharp forward edge or with projecting fingers in a forward area thereof with a rear perforated shovel-like portion. These shovel-like portions are provided with perforations to screen the earth to separate it from the weeds. These perforations are either too small or clog up with weeds due to their construction and therefore it is difficult to separate the earth gathered from the weeds. These garden tools are usually plunged into the ground to cut the roots of the weeds to be removed. These tools are usually shaken to separate the earth from the weeds, During this action, many of the roots and weeds fall out of the garden tool and back into the flowerbed or grass area with the weeds re-growing in the grass or flowerbed. This is particularly so with U.S. Pat. No. 2,909,385 wherein the shovel portion does not have perforations but merely a forward cutting edge.

Furthermore, because the perforated portions have small openings, these openings quickly clog up with uprooted weeds, small stones or earth chunks and prevent the weeds from being trapped by the tool. It is also difficult to plunge the garden tool into the soil and move it therein to uproot a large portion of soil in a single scooping motion. The shape of these garden tools also makes it difficult to effect a scooping motion in soil due to the flat shovel like design of these tools which offer resistance against the earth. They are also not aesthetically pleasing in design.

### SUMMARY OF INVENTION

It is a feature of the present invention to provide a weed removal garden hand tool which substantially overcomes the above-mentioned disadvantages of the prior art.

According to a further feature of the present invention there is provided a weed removal garden hand tool which is easily displaceable in earth by permitting the passage of earth through the tool while uprooting weeds while permitting weeds to be gathered and earth to be shaken out of a weed retaining basket of the tool while retaining the weeds in the basket.

A further feature of the present invention is to provide a weed removal garden hand tool which facilitates uprooting weeds along border edges of grassed or paved areas.

Another feature of the present invention is to provide a weed removal garden hand tool which is aesthetically pleasing and wherein the handle thereof is interchangeable for design purpose or for use by a person standing upright.

According to a still further feature of the present invention there is provided a weed removal garden hand tool wherein the rear weed retaining basket of the tool has a concavely shaped bottom wall to facilitate the passage of the scoop in the earth in a long scooping or plowing motion.

According to the above features, from a broad aspect, the present invention provides a weed removal garden hand tool comprising a scoop having a forward root cutting portion and a rear weed retaining basket. The forward root cutting portion has projecting spaced-apart fingers extending from a forward edge of a bottom wall of the rear weed retaining basket. The forward edge, between the fingers, is a beveled root cutting edge. Opposed outer ones of the fingers have upwardly formed side flanges merging with opposed side walls of the rear weed retaining basket. The weed retaining basket has an upstanding rear wall. The bottom wall and opposed side walls of the basket have through bore formations shaped and disposed to permit the passage of earth while uprooting weeds in earth. The weed retaining basket retains weeds and cut roots therein while permitting earth to pass therethrough during use in earth and to be shaken out of the weed retaining basket. A handle is secured to the upstanding rear wall and extends outwardly thereof.

### BRIEF DESCRIPTION OF DRAWINGS

A preferred embodiment of the present invention will now be described with reference to the accompanying drawings in which:

FIG. 1 is a perspective view of the weed removal garden hand tool of the present invention;

FIG. 2 is a side view of the weed removal garden hand tool;

FIG. 3 is a fragmented bottom view thereof;

FIG. 4 is a fragmented view showing a detachable handle secured to the rear wall of the scoop of the weed removal garden hand tool;

FIG. 5 is a fragmented section view showing a removable hand grip secured to the handle rod;

FIG. 6 is a schematic illustration showing the garden hand tool in use uprooting weeds from earth;

FIG. 7 is a further schematic view showing the garden hand tool of the present invention uprooting weeds in earth adjacent a paved surface;

FIG. 8 is a further schematic view similar to FIG. 7, but showing the garden hand tool uprooting weeds against a straight edge grass portion;

FIG. 9 is a perspective view illustrating how the earth is separated from the weeds by shaking the garden hand tool;

FIG. 10 is a perspective view illustrating the garden hand tool's raking feature; and

FIG. 11 shows a modification of the garden hand tool.

### DESCRIPTION OF PREFERRED EMBODIMENTS

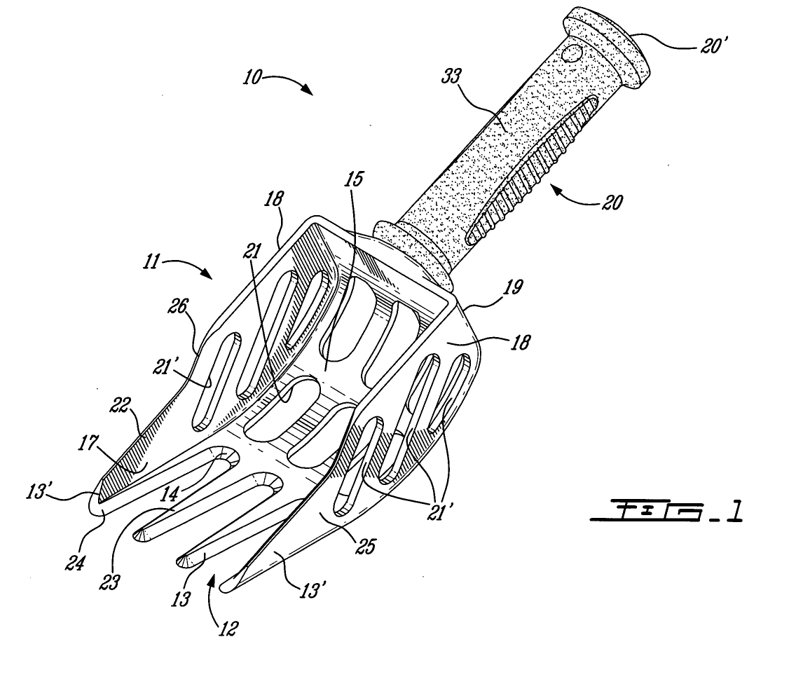

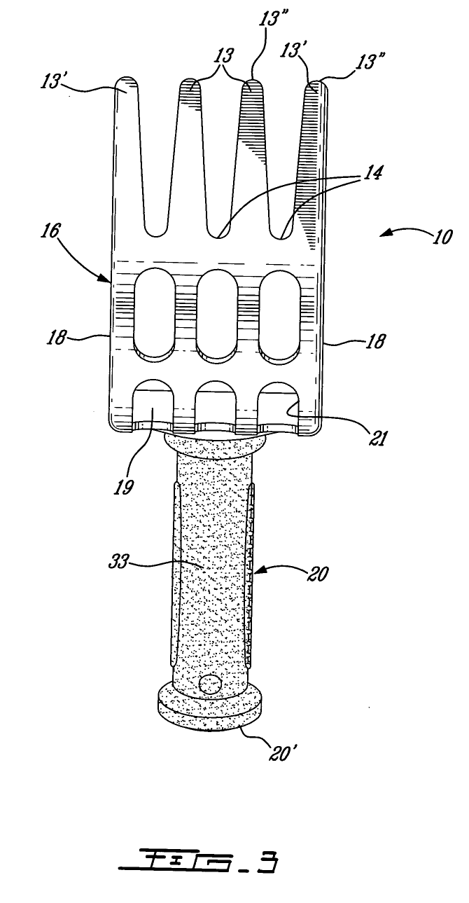

Referring now to the drawings and more particularly to FIGS. 1 to 3, there is shown generally at 10 the weed removal garden hand tool of the present invention. It is comprised of a scoop 11 having a forward root cutting portion 12 provided with projecting, spaced-apart, fingers 13 extending from a forward edge 14 of a bottom wall 15 of a rear weed retaining basket 16. The forward edge 14 of the basket between the fingers 13 is a beveled root cutting edge.

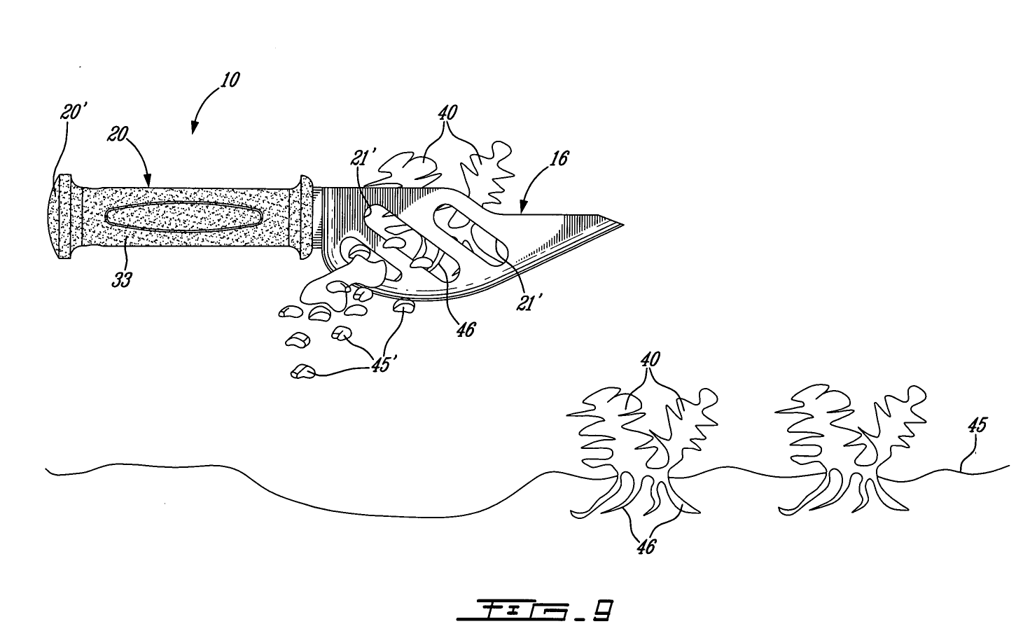

As hereinshown, the opposed outer ones of the fingers, namely fingers 13′, have upwardly formed side flanges 17 which merge upwardly with opposed side walls 18 of the rear weed retaining basket 16. The weed retaining basket has an upstanding rear wall 19 to which is attached a handle 20. The weed retaining basket 16 is also provided with large through bore formations 21 in the bottom wall 15 thereof and similar formations 211 in the side walls 18. These through bore formations 21 and 21′ are shaped and disposed to permit the passage of earth while uprooting weeds 40 in the earth of a plant bed 45 and for the separation of earth from the roots 46 of weeds 40 gathered therein when shaken above ground, as illustrated in FIG. 9.

As can also be seen from FIGS. 1 to 3, the projecting fingers 13 are provided with beveled side edges 22 sloping downwardly outward from a top surface 23 of the fingers 13. These beveled side edges 22 of adjacent fingers 13 merge with one another in the forward root cutting edge 14 which is concavely shaped and also beveled to provide this root cutting edge. The beveled edges of the fingers provide for ease of displacement of the tool in earth in straight or curved trajectories.

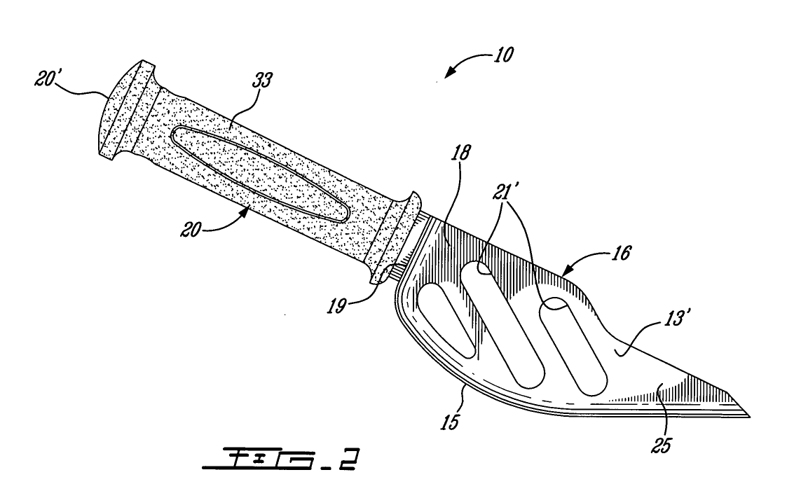

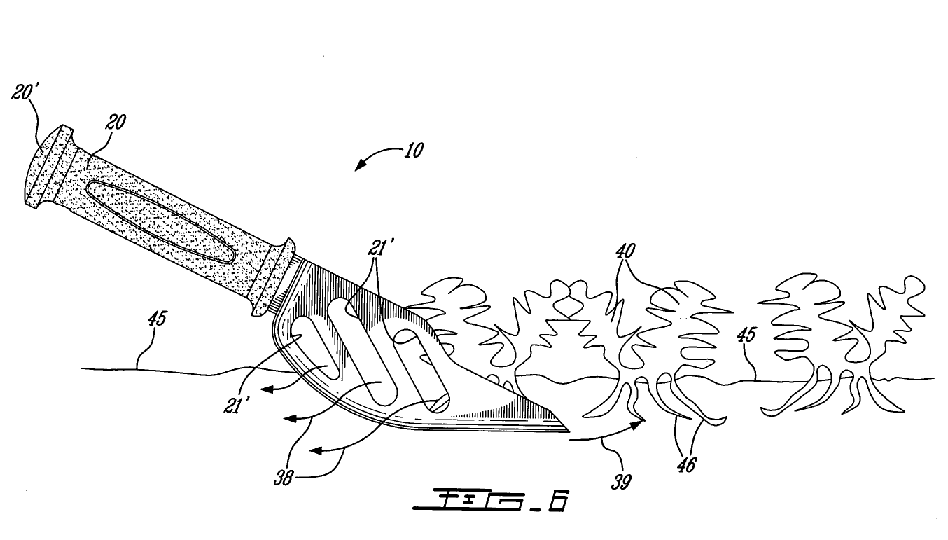

As better seen in FIG. 2, the rear weed retaining basket 16 has a concavely shaped bottom wall 15 extending from the rear wall 19 to the forward cutting edge 14 whereby to facilitate the passage of the scoop in earth in a scooping or plowing motion as will be described later with reference to FIG. 6.

The side flanges 17 of the opposed fingers 13′ are sloped upwardly from a tip end 24 which has a sharp bevel extending inwardly from a top edge of flat outer side wall 25 of these flanges whereby to provide for a sharp cutting edge all along the top edge of the side flanges 17. As hereinshown, the straight upwardly sloping edge 22 of the flanges of the opposed projecting fingers 13′ each merge into a steep rearwardly angled top front edge 26 of a rear portion of the flanges 17. The steep rearwardly angled top front edge 26 is also beveled inwardly to form an extension of the beveled cutting edge 22 for edge trimming, as will be described later.

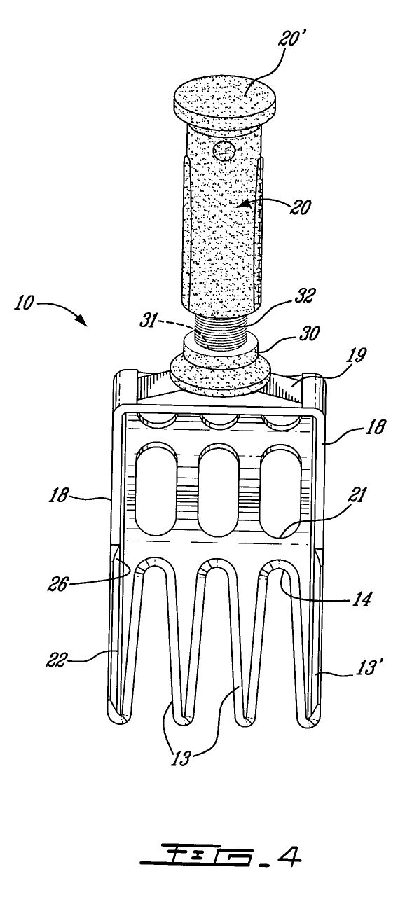

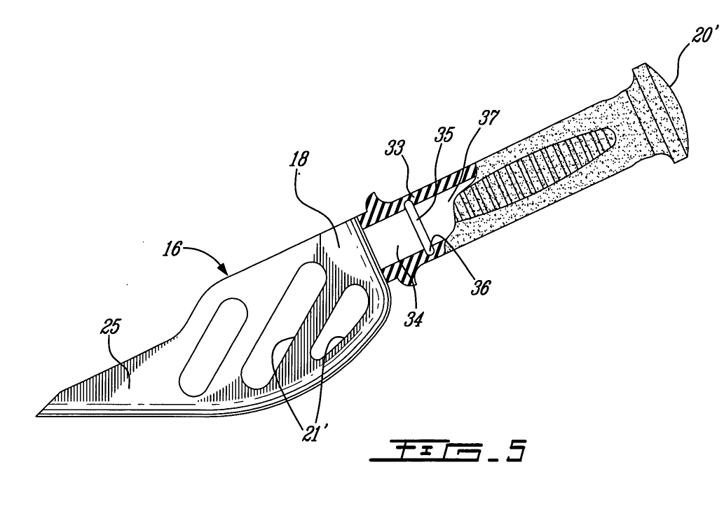

As shown in FIG. 4, the handle 20 may be provided as a removable handle whereby to provide handles of different lengths and/or different aesthetically pleasing design and color. To achieve this feature a handle socket 30 with an inner thread 31 may be formed with or secured to the rear wall 19 of the basket 16. The forward end of the handle 20 would also be provided with a threaded stem portion 32 to engage within the handle socket 30 for removable engagement therewith. Further, the handle 20, as better shown in FIG. 1, may have an interchangeable handle grip 33 removably secured to a handle rod 34 secured and projecting from the rear wall 19 of the weed retaining basket 16. The handle rod would be provided with retention means in the form of one or more annular ridges 35 to engage within annular cavities 36 provided in the inner wall 37 of the interchangeable flexible handle grip 33 as illustrated in FIG. 5.

With reference again to FIGS. 1 to 3, it can be seen that the through bore formations 21 and 21′ are elongated, substantially rectangular-shaped through bore formations having curved outer edges and straight elongated side edges. The trough bore formations 21 in the bottom wall is of the weed retaining baskets 16 are longitudinally aligned between the fingers 23 and are of substantially the same width as the space between the rear end portions of these adjacent fingers. The rear through bore formations also extend in a lower portion of the rear wall to again facilitate displacement in earth. These large through bore formations occupy approximately 50 percent of the surface area of the basket to permit ease of passage (less resistance) of the scoop into the earth to uproot weeds, as illustrated in FIG. 6. As shown during the scooping or plowing motion, earth passes through the through bore formations 21 and 21′ as indicated, for example, by arrows 38 permitting the scoop portion of the garden hand tool to be guided along a longer passage into the earth with reduced resistance. This permits the scoop to uproot a larger section of the earth as with scoops not having such large openings and clogging up. Further, the concavely shaped bottom wall 15 facilitates the passage of the scoop in earth in a guided scooping motion as shown by the arc 39 in FIG. 6. Still further the tip ends 13″ of the fingers 13 are convexly curved tip ends with the bevel side edges 22 of the fingers 13 merging about the tip end to form beveled fingers and this further facilitates the passage of the scoop into the earth while imparting forward or side motion thereof.

It can be seen that the rectangular shape through bore formations 21, in the opposed side walls 18 are also disposed at an angle sloping rearwards and upwardly from a lower end thereof, which lower end is disposed adjacent the bottom wall 15. This angular positioning also facilitates the passage of earth when the scoop is pushed into a forward scooping or plowing motion through earth, as illustrated in FIG. 6. As previously mentioned, the through bore formations 21 and 21′ are dimensioned to constitute substantially 50 percent of the surface area of the rear weed retaining basket and this has been found to be preferable in permitting easy passage of the scoop into the earth while uprooting weeds and retaining the weeds in the scoop while at the same time evacuating some of the earth and permitting the passage of small stones therethrough while retaining some of the earth attached to the roots of weeds. The large openings permit ease of removal of earth from the rear weed retaining basket by imparting a shaking action to the weed retaining basket by the use of the handle whereby substantially only the weeds and earth will remain in the scoop for disposal.

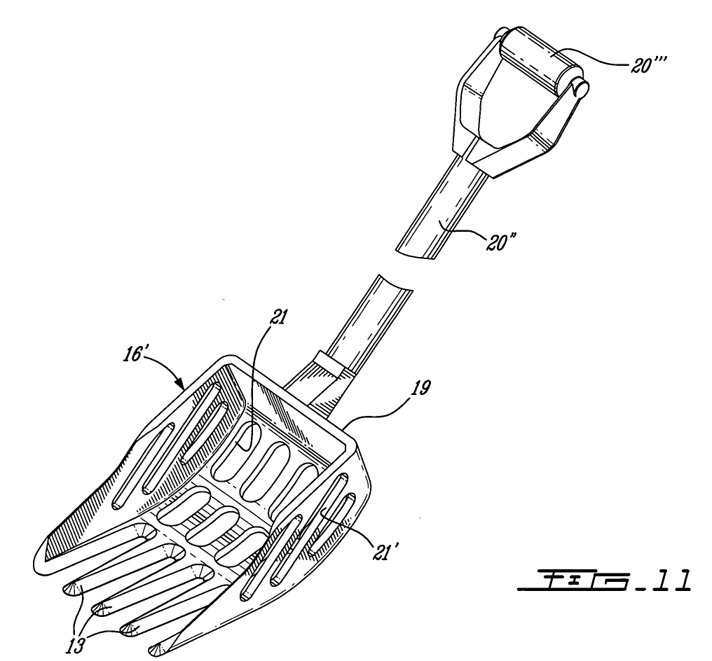

The weed removal garden hand tool of the present invention is preferably, although not exclusively, manufactured from an aluminum casting or as an integrally molded plastic garden tool which is aesthetically pleasing in design while permitting very efficient use in the removal of weeds or other debri from earth. Of course, the garden hand tool may also be formed of other suitable materials and by other suitable methods. Still further the handle 20 as herein illustrated is a short handle, it is also conceivable that the basket may be made much larger, like a shovel as shown at 16, in FIG. 11, with the handle being an elongated shaft 20″ having a handle grip 20′″ at a free end for use as a weed removal tool by a standing user person.

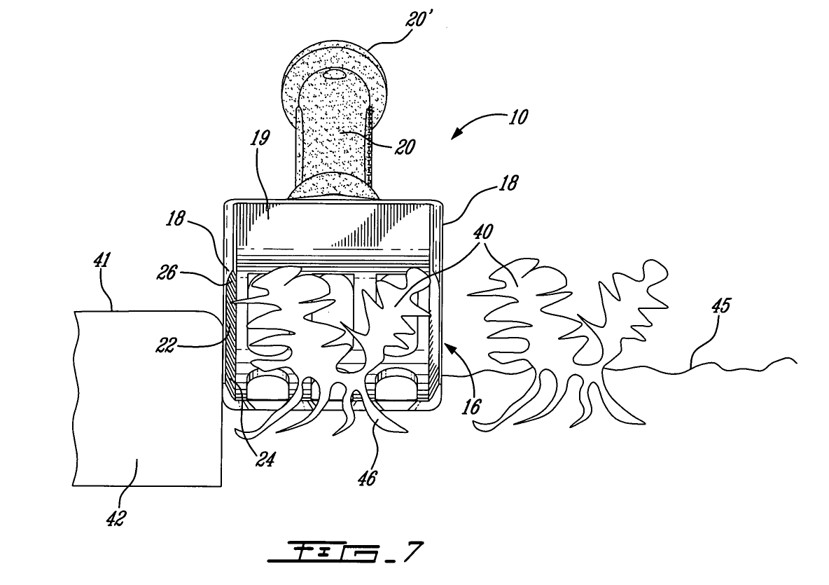

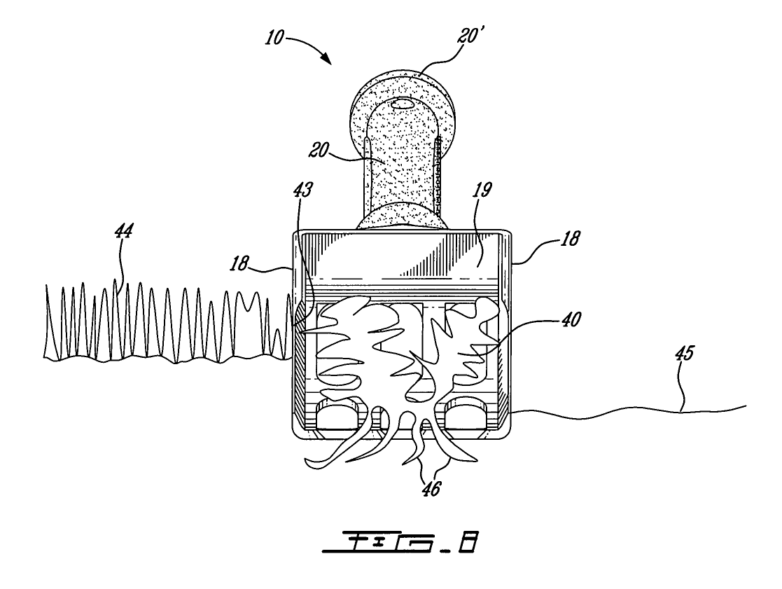

With reference now to FIGS. 7 and 8, it can be seen that the side flanges of the outer projecting fingers 13′ provide for another added feature of the weed removal garden hand tool of the present invention. Because the opposed side walls of the basket as well as the opposed projecting fingers 13 are flat, vertical side walls provided with tapered edges 22 and 26 which constitute cutting edges, it is advantageously used to remove weeds, such as the weeds 40, which grow adjacent paved surfaces 41, such as illustrated in FIG. 7, herein constituted by paving stone 42 or a sharply cut “S” edge 43 of a grass area 44 growing adjacent a flower or plant bed 45. By moving the scoop along this edge and in substantially frictional contact therewith, as illustrated in FIGS. 7 and 8, these weeds 40 and their roots 46 can be easily removed thus providing for a straight weed-free edge and a depression in the earth delineating a paved or grass surface from a plant bed. The scoop side flanges 17 also provide for the trimming of grass areas growing into flower beds or around mulched areas, particularly such areas about tree trunks. The handle 20 is also provided with an enlarged dome-shaped end 20′ to provide an impacting surface to strike against the tool with the palm of a user's free hand to impact the tool to cut through roots that are hard to dislodge. This is also useful when the tool is used for edge trimming as shown in FIGS. 7 and 8.

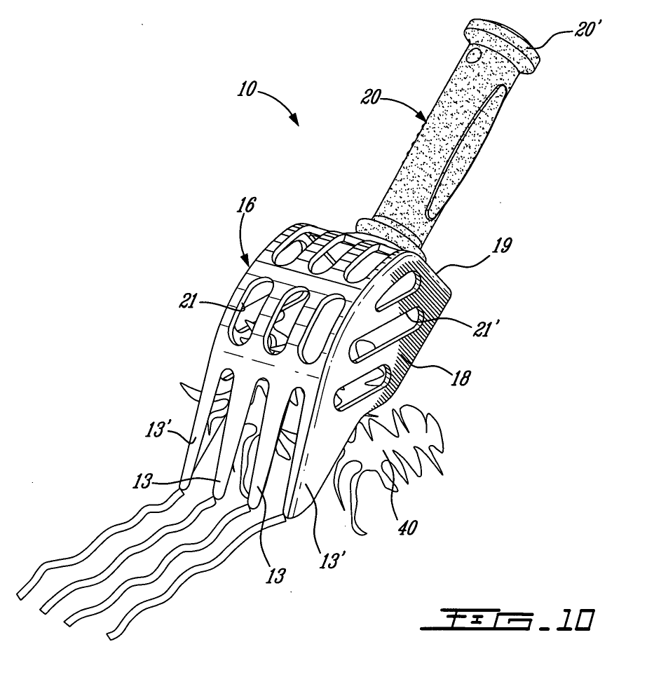

Another feature of the garden hand tool is illustrated in FIG. 10. As shown, the tool is also used as a rake to remove loose debris resting on the surface of the earth, such as uprooted weeds. This is done by simply inverting the garden hand tool and using the fingers 13 and 13′ as raking fingers. Their tapered feature also facilitates their penetration in the earth's top surface to remove any loosely engaged weeds.

It is within the ambit of the present invention to cover any obvious modifications of the preferred embodiment described herein, provided such modifications falls within the scope of the appended claims.

1. A garden tool comprising a scoop formed of rigid non-flexible material and having a forward cutting portion integrally formed with a rear basket portion, said forward cutting portion having rigid, non-flexible projecting spaced-apart fingers extending from a forward cutting edge of a bottom wall of said rear basket portion, said forward cutting edge between said fingers being a beveled cutting edge, said fingers tapering inwardly from a rear end thereof to a narrow free beveled tip end thereof, opposed outer ones of said fingers having upwardly formed side flanges merging with opposed side walls of said rear basket portion, said basket having an upstanding rear wall, at least said bottom wall and opposed side walls having elongated through bore formations shaped and disposed to permit the passage of earth matter, said bottom wall of said rear basket portion having a flat concave shape extending from said forward cutting edge and into said rear wall whereby to facilitate the passage of said scoop in earth when said scoop is displaced in a scooping motion through earth, said basket portion retaining matter larger than said through bore formations while permitting other earth matter to pass therethrough during use in scooping earth matter and shaking earth matter retained in said basket portion, and a handle secured to said upstanding rear wall and extending outwardly rearwards thereof.

2. A garden tool as claimed in claim 1 wherein said fingers have beveled side edges sloping downwardly outwards from a top surface thereof, said beveled side edges of adjacent fingers, merging with one another in said beveled root cutting edge which is concavely shaped.

3. (canceled)

4. A garden tool as claimed in claim 1 wherein said side flanges are sloped upwardly from a tip end of said opposed outer ones of said fingers to form a straight upwardly sloping edge, said straight upwardly sloping edge being beveled inwardly to form a cutting edge.

5. A garden tool as claimed in claim 4 wherein said straight upwardly sloping edge merges into a steep rearwardly angled top front edge of said opposed side walls, said steep rearwardly angled top front edge being beveled inwardly to form a further cutting edge for edge trimming.

6. (canceled)

7. (canceled)

8. A garden tool as claimed in claim 1 wherein said elongated through bore formations are substantially rectangular shaped trough bore formations.

9. A garden tool as claimed in claim 1 wherein said through bore formations in said bottom wall of said weed retaining basket are longitudinally aligned between said fingers and of substantially the same width as the space between a rear end portion of adjacent fingers.

10. (canceled)

11. A garden hand tool as claimed in claim 2 wherein said free beveled tip end is a convexly curved tip end with said beveled side edges of said fingers merging about said tip end to form said beveled tip end.

12. A garden tool as claimed in claim 8 wherein said rectangular shaped through bore formations in said opposed side walls are disposed at an angle sloping rearwards and upwards from a lower end disposed adjacent said bottom wall to facilitate the passage of earth matter when said scoop of said garden hand tool is pushed in a forward and upward scooping or plowing motion through the earth matter.

13. A garden tool as claimed in claim 8 wherein said through bore formations are dimensioned to constitute substantially 50% of the surface area of said rear weed retaining basket.

14. (canceled)

15. A garden tool as claimed in claim 1 wherein said handle is an elongated handle permitting the use of said weed removal garden tool by a standing user person.

16. (canceled)

17. A garden tool as claimed in claim 1, wherein said handle is provided with an enlarged dome-shaped end to provide an impacting surface to apply impacting blows on said tool to cut through roots which are hard to dislodge.

18. (canceled)

19. (canceled)

20. (canceled)

21. (canceled)

22. (canceled)
